(19) United States
(12) Patent Application Publication
(10) Pub. No.: US 2026/0341310 A1
(43) Pub. Date: Oct. 29, 2026

(54) VOICED-OVER MULTIMEDIA TRACK GENERATION

(71) Applicant: GAN STUDIO INC., Perrysburg, OH (US)

(72) Inventors: Amogh GULATI, New Delhi (IN); Soma SIDDHARTHA, Hyderabad (IN); Manash Pratim BARMAN, Kamrup (IN); Ankur BHATIA, Kanpur (IN); Suvrat BHOOSHAN, New Delhi (IN)

(21) Appl. No.: 19/464,313

(22) Filed: Jan. 29, 2026

Related U.S. Application Data
(62) Division of application No. 18/842,687, filed on Mar. 1, 2023.

(30) Foreign Application Priority Data
Mar. 1, 2022 (IN) 202211011128

(51) Int. Cl. G11B 27/036; G06F 40/58; G06V 20/40; G06V 40/16; G10L 13/027; G10L 13/10; G10L 17/02; G10L 17/18; G10L 21/0208; G10L 25/21; G10L 25/57; G10L 25/90; G10L 25/93

(52) U.S. Cl. CPC G11B 27/036; G06F 40/58; G06V 20/46; G06V 40/161; G10L 13/027; G10L 13/10; G10L 17/02; G10L 17/18; G10L 21/0208; G10L 25/21; G10L 25/57; G10L 25/90; G10L 25/93; G10L 2013/105

(57) ABSTRACT

Examples approaches for generating a final media track in a final language by altering an initial media track in an initial language, are described. In an example, an audio generation model is used to convert or translate an initial audio track of an initial language into a final audio track of a final language. Further, a video generation model is used to manipulate or alter movement of lips of a speaker in an initial video track based on the final audio track and a final text corresponding to each individual sentences. Once generated, the final audio track and the final video track are merged to generate a final audio-visual track or final media file.

### CROSS-REFERENCE TO RELATED APPLICATION(S)

This application is a divisional of U.S. Patent Application No. 18/842687, filed Aug. 29, 2024; which claims the benefit of IN202211011128, filed on Mar. 1, 2022, which are hereby incorporated by reference as if fully set forth herein.

### BACKGROUND

In recent years, with the rapid development of digital technology and the increased accessibility of digital media, the consumption of digital media has increased drastically. Digital media combined with internet and personal computing further increased the demand of digital content in different parts of the world. However, one of the barriers in providing such content worldwide is variation in language of people with change in geographical locations. For example, the content which may be created having an audio track based on a single language is not consumed by users who speak different languages. In order to make such content consumable, the content needs to be altered in such a manner that it may cater the demands of people of different languages. To this end, voice-over artist trained in different languages may be hired for dubbing the audio track in target language to replace the original audio track of the content.

### BRIEF DESCRIPTION OF THE SEVERAL VIEWS OF THE DRAWINGS

The detailed description is provided with reference to the accompanying figures, wherein:

FIG. 1 illustrates a detailed block diagram of an audio generation system, as per an example;

FIG. 2 illustrates a method for generating a final audio track based on a final audio characteristic information selected from a data repository, in accordance with exemplary implementation of the present subject matter;

FIG. 3 illustrates a detailed block diagram of a video generation system, as per example; and

FIG. 4 illustrates a method for generating a final video portion using a video generation model, as per an example.

It may be noted that throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

As may be understood, for any content to be consumed by a consumer, the two most important things are namely, its communication to the consumer and the other one is its understandability (the message that content wants to convey to consumer). Advent of digital content, such as digital images, videos, web pages, websites, social media, digital data, digital audio and e-books, and digital technology facilitated the content developers to reach out to the people living in different parts of the world without being physically present in front of them. Therefore, the first barrier, i.e., communication part was resolved by enhancement in digital media, digital technology, and internet. However, the other barrier, i.e., understandability of the content to the user is still a bigger problem. Since people living in different parts around the world speak different languages based on their ethnicity, culture and region, it is very important for the content developer to make the content in such a format that it would be consumed by people of different languages or as many people as possible.

Contrary to this, generally, media content is initially created in a single language with the corresponding video part, e.g., lips of the character in the video, also move in sync with audio track in only single language. Therefore, in order to make such content consumable by different people, such content needs to be dubbed or voiced over, in a different language based on the requirement of user. Once dubbed, the original audio track may be replaced with a voiced over audio track during postproduction. To achieve the same, the voice over artists who knows different languages reads from a printed script based on which the voiced over audio track may be created.

In furtherance to this, if content which needs to be communicated include voices of several speakers, then it becomes very difficult for the content developer to dub that content. The reason being is that a large number of voice-over artist may have to be hired by the content developer and hiring of such a large number of artists involve higher cost and higher consumption of time as well. To overcome this drawback, different solutions have been proposed in different period of time. For example, one of the solutions is, providing subtitles in the final language as closed captions on the content enabling the consumer to understand the context from the captions. However, users who try to understand from subtitles always have a complain that they need to spend a lot more time with their eyes on the subtitles than the original content, which eventually hinders understanding and whole experience of the user.

As per another conventional solution, several TTS (text to speech) voice over systema are present in the market which converts texts scripts into corresponding audio voice. For example, an initial audio is firstly converted to text in first language and then translated into the second language. Thereafter, the text in the second language is used in the TTS model to generate a final audio. However, such mechanisms also fail on several aspects, e.g., the vocal characteristics of the dubbed audio are not consisting with the attributes of the speaker in the initial media file. For example, in the original video, the character who is communicating is of 25 years of age having certain vocal characteristics which are related to his age and sex, however, the TTS generate the final audio irrespective of these speaker attributes, which eventually degrades user experience. Further, none of the available solution enable alteration of certain video parts, such as lip movement of the person speaking in the video, corresponding to the changed audio which eventually results in bad user experience.

Approaches for generating a final media track in a final language by altering an initial media track in an initial language, are described. In an example, there may be an initial media file including an initial audio track and an initial video track in the initial language which needs to be altered into a final audio track and a final video track in the final language. In an example, the initial media file includes audio track representing voices and video track representing corresponding visuals of multiple speakers, e.g., a first speaker and a second speaker, having certain speaker attributes which are either communicating with each other or speaking individually. Examples of speaker attributes include, but may not be limited to, sex of the speaker, age of speaker, vocal speed of the speaker, and combination thereof. In such a case, the audio track includes voices of speakers vocalizing some text which may be considered as a sequence of sentences spoken by different speakers.

In operation, initially, a list of individual sentences with a speaker identifier assigned to each of the individual sentences may be obtained. In an example, the initial audio track comprised in the initial media file is converted into text which is further processed to form a list of individual sentences. Such conversion of text into the list of individual sentences is performed by segregating text based on the silences between the voices of subsequent sentences. Once segregated, a speaker identifier is assigned to each of the individual sentences based on an initial audio characteristic information of each of the speaker, e.g., first speaker and the second speaker. The process of assigning speaker identifier corresponding to each of the individual sentences is generally known as ‘speaker diarization’.

Returning to the present example, once the list of individual sentences with corresponding speaker identifier assigned is obtained, a final audio characteristic information for each of the speakers are determined based on a speaker attribute of the first speaker and the second speaker. In an example, in the original audio track, individual sentences may be spoken by different speakers with certain initial audio characteristic information representing variation in vocal characteristics of different speakers. Therefore, in order to dub the initial audio track in final language, final audio characteristic information needs to be determined to be used to convert a final text into corresponding final audio portion. In an example, to determine the same, speaker attributes of speakers vocalizing in the initial media file are used as a reference to search for final audio characteristics from a data repository. The data repository may include a plurality of final audio characteristic information stored based on speaker attributes for a plurality of final languages. Examples of speaker attributes include, but may not be limited to, sex, age, and vocal speed of the speaker.

Continuing further, once the final audio characteristics are determined, a final audio portion corresponding to each of the individual sentences are generated using an audio generation model. Such generation is based on the final audio characteristics determined for each speakers and a final text determined corresponding to each of the individual sentences. In an example, the final text represents translation of individual sentence into final language. In one example, final text is generated by using a neural machine translation model which outputs one or more finals texts from which one of appropriate final text is selected for conversion. Once the final audio portion for each of the individual sentences are generated, a final audio track dubbed in the final language is generated by merging final audio portion of each of the individual sentences.

In an example, it may be noted that, the audio generation model is a machine learning or neural network model which may be trained based on a plurality of audio tracks of a plurality of speakers to generate an output audio corresponding to an input text based on input audio characteristic information. Therefore, in the present case, the audio generation model is used to generate final audio portion corresponding to the final text based on the final audio characteristic information.

In one example, the audio generation model may be trained based on a training audio track and a training text data. During such training, a training audio characteristic information is extracted from the training audio track using phoneme level segmentation of the training text data. The training audio characteristic information further includes training attribute values corresponding to a plurality of training audio characteristics. Examples of training audio characteristics include, but are not limited to, number of phonemes, types of phonemes present in the initial audio track, duration of each phoneme, pitch of each phoneme, and energy of each phoneme. Thereafter, the audio generation model is trained based on the training audio characteristic information to generate the final audio corresponding to the final text portion.

Returning to the present example, once the final audio track is generated, the final video track may also be generated by using a video generation system. The generation of the final video track is based on an initial media file. In an example, the initial media file includes, but may not be limited to, an initial audio track, an initial video track, and an initial audio portion, a final audio portion, and a final text corresponding to each of the individual sentences spoken in the initial media file. In one example, the initial audio portion, final audio portion, and the final text corresponding to each of the individual sentences may be generated while generating the final audio track. For example, while converting the initial audio track into the final audio track, initial audio portions corresponding to each of the sentences have been determined to convert them into final audio portions based on the final text. Therefore, the initial audio portion, final audio portion, and final text corresponding to each of the individual sentences generated while converting the initial audio track into the final audio track are used here.

Once the initial media file is obtained, the initial video track included in the initial media file is divided into a plurality of initial video clips by splitting based on the duration of each of the initial audio portions. Therefore, each of the initial video clips represent video or visual data while the individual sentence corresponding to that video clips is being spoken in the initial video track. Thereafter, each of the initial video clips is processed with corresponding final audio portion and final text based on a video generation model to generate a final video portion. Such final video portion is generated for each of the initial video clips. In an example, final video portion includes a portion of a speaker’s face visually interpreting the movement of lips as the speaker is vocalizing the final audio portion corresponding to the final text. For example, final video portion displays only a set of pixels representing movement of lips based on the final audio portion corresponding to the final text.

Returning to the present example, once generated, the final video portion of each of the initial video clips is merged with a corresponding intermediate video clip to generate a final video clip. In an example, the intermediate video clip includes video or visual data corresponding to the initial video clip with a portion displaying lips of a speaker blacked out. Once the final video portion representing those movement lips are merged with the intermediate video clip with lips portion blacked out, the final video clip corresponding to the initial video clip is generated. Such a process is repeated for each of the initial video clip to generate final video clip corresponding to each of the initial video clip and then merged together to form the final video track. Now, the final audio track and the final video track is merged or associated with each other to form a final audio-video or final multimedia track.

In an example, the video generation model, similar to the audio generation model, may be a machine learning mode, a neural network-based model or a deep learning model which is trained based on a plurality of video tracks of a plurality of speakers to generate an output video portion corresponding to an input text with values of video characteristics corresponding to the lips of the speaker being selected from a plurality of visual characteristics of the plurality of speakers based on an input audio and visual characteristics of the rest of the face of the speaker.

Such video generation model may be further trained based on a training information including a plurality of training video frames accompanying corresponding training audio data and training text data spoken in those frames. In an example, each of the plurality of training video frames comprises a training video data with a portion comprising lips of a speaker blacked out. In one example, a training audio characteristic information is extracted from the training audio data associated with each of the training video frames using phoneme level segmentation of training text data and a training visual characteristic information is extracted from the plurality of video frames. The training audio characteristic information further includes training attribute values corresponding to a plurality of training audio characteristics.

Examples of training audio characteristics include, but are not limited to, number of phonemes, types of phonemes present in the initial audio track, duration of each phoneme, pitch of each phoneme, and energy of each phoneme. Further, examples of training visual characteristic include, but are not limited to, color, tone, pixel value of each of the plurality of pixel, dimension, orientation of the speaker’s face based on the training video frames. Thereafter, the video generation model is trained based on the extracted training audio characteristic information and training visual characteristic information to generate a final video portion having a final visual characteristic information corresponding to a final text. Examples of final visual characteristic include, but are not limited to, color, tone, pixel value of each of the plurality of pixel, dimension, and orientation of the lips of the speaker.

The explanation provided above and the examples that are discussed further in the current description are only exemplary. For instance, some of the examples, may have been descried in the context of audio-visual content including the first speaker and the second speaker communicating with each other. However, the current approaches may be adopted with any number of speakers communicating in any manner and for other application areas as well, such as interactive voice response (IVR) system, automated chat systems, or such, without deviating from the scope of the present subject matter.

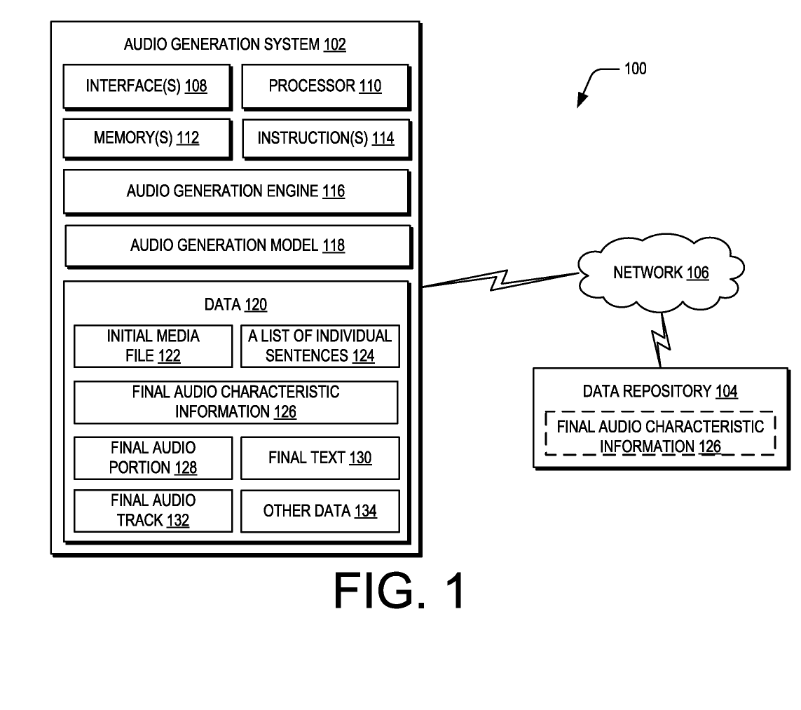

The manner in which the example computing systems are implemented are explained in detail with respect to FIGS. 1-4. While aspects of described computing system may be implemented in any number of different electronic devices, environments, and/or implementations, the examples are described in the context of the following example device(s). It may be noted that drawings of the present subject matter shown here are for illustrative purpose and are not to be construed as limiting the scope of the claimed subject matter.

FIG. 1 illustrates a communication environment 100, depicting a detailed block diagram of an audio generation system 102 (referred to as system 102), for converting an initial audio track of an initial language into a final audio track of a final language. The initial audio track may be obtained from a user via a computing device as part of an initial media file which further includes an initial video track. The computing device is communicatively coupled with the system 102 to translate or convert audio track of the initial media file into the final audio track in the final language.

In general, the system 102 performs voice over of the initial audio track of the initial media file by changing an initial audio characteristic information of the speakers with a final audio characteristic information while converting a final text into a final audio portion. The final audio characteristic information is selected based on the speaker attributes, such as sex, age, vocal speed, of the speakers. The system 102, in an example, may relate to any system capable of receiving user’s inputs, processing it, and correspondingly providing output based on the received user’s inputs.

The system 102 may be coupled to a data repository 104 over a communication network 106 (referred to as network 106). The data repository 104 may be implemented using a single storage resource (e.g., a disk drive, tape drive, etc.), or may be implemented as a combination of communicatively linked storage resources (e.g., in the case of Infrastructure-as-a-service), without deviating from the scope of the present subject matter.

The network 106 may be either a single communication network or a combination of multiple communication networks and may use a variety of different communication protocols. The network 106 may be a wireless network, a wired network, or a combination thereof. Examples of such individual communication networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NON), Public Switched Telephone Network (PSTN). Depending on the technology, the network 106 includes various network entities, such as gateways, routers; however, such details have been omitted for the sake of brevity of the present description.

The system may include interface(s) 108, processor 110, and a memory 112. The interface(s) 108 may allow the connection or coupling of the system 102 with one or more other devices, through a wired (e.g., Local Area Network, i.e., LAN) connection or through a wireless connection (e.g., Bluetooth®, WiFi). The interface(s) 108 may also enable intercommunication between different logical as well as hardware components of the system 102. The processor 110 may be implemented as microprocessors, microcomputers, microcontrollers, digital signal processors, central processing units, state machines, logic circuitries, and/or any devices that manipulate signals based on operational instructions. Among other capabilities, the processor 110 is configured to fetch and execute computer-readable instructions stored in the memory 112.

The memory 112 may be a computer-readable medium, examples of which include volatile memory (e.g., RAM), and/or non-volatile memory (e.g., Erasable Programmable read-only memory, i.e., EPROM, flash memory, etc.). The memory 112 may be an external memory, or internal memory, such as a flash drive, a compact disk drive, an external hard disk drive, or the like. The memory 112 may further include data which either may be utilized or generated during the operation of the system 102.

The system 102 may further include instructions 114 and an audio generation engine 116. In an example, the instructions 114 are fetched from the memory 112 and executed by the processor 110 included within the system 102. The audio generation engine 116 may be implemented as a combination of hardware and programming, for example, programmable instructions to implement a variety of functionalities. In examples described herein, such combinations of hardware and programming may be implemented in several different ways. For example, the programming for the audio generation engine 116 may be executable instructions, such as instructions 114.

Such instructions may be stored on a non-transitory machine-readable storage medium which may be coupled either directly with the system 102 or indirectly (for example, through networked means). In an example, the audio generation engine 116 may include a processing resource, for example, either a single processor or a combination of multiple processors, to execute such instructions. In the present examples, the non-transitory machine-readable storage medium may store instructions, such as instructions 114, that when executed by the processing resource, implement audio generation engine 116. In other examples, the audio generation engine 116 may be implemented as electronic circuitry.

The system 102 may include an audio generation model, such as the audio generation model 118. In an example, the audio generation model 118 may be a multi-speaker audio generation model which is trained based on a plurality of audio tracks corresponding to a plurality of speakers to generate an output audio corresponding to an input text with attribute values of the audio characteristics being selected from a plurality of audio characteristics of the plurality of speaker based on an input audio. In an example, the audio generation model 118 may also be trained based on the initial audio track and initial list of individual sentences.

In an example, the system 102 may further include a training engine (not shown in FIG. 1) for training the audio generation model 118. In one example, the training engine obtains the training information including training audio track and the training text either from the user operating on the computing device or from the sample data repository, such as data repository 104. Thereafter, a training audio characteristic information is extracted from the training audio track by the system.

In an example, the training audio characteristic information is extracted from the training audio track using phoneme level segmentation of training text data. The training audio characteristic information further includes plurality of training attribute values for the plurality of training audio characteristics. Examples of training audio characteristics include, but may not be limited to, type of phonemes present in the training audio track, number of phonemes, duration of each phoneme, pitch of each phoneme, and energy of each phoneme.

Continuing with the present example, once the training audio characteristic information is extracted, the training engine trains the audio generation model based on the training audio characteristic information. In an example, while training the audio generation model, the training engine classify each of the plurality of training audio characteristic as one of a plurality of pre-defined audio characteristic category based on the type of the training audio characteristics. Once classified, the training engine assigns a weight for each of the plurality of training audio characteristics based on the training attribute values of the training audio characteristics.

Returning to the present example, once the audio generation model 118 is trained, it may be utilized for assigning a weight for each of the plurality of audio characteristics. For example, an input audio characteristic information which needs to be used for converting an input text into an audio portion may be processed based on the audio generation model. In such a case, based on the audio generation model, the audio characteristic information is weighted based on their corresponding attribute values. Once the weight of each of the audio characteristic is determined, the audio generation model utilizes the same and generate the output audio portion corresponding to the input text.

Returning the explanation of features of the system 102, the system 102 further includes a data 120 including an initial media file 122, a list of individual sentences 124, a final audio characteristic information 126, a final audio portion 128, a final text 130, a final audio track 132, and other data 134. Further, the other data 134, amongst other things, may serve as a repository for storing data that is processed, or received, or generated as a result of the execution of instructions by the processing resource of the audio generation engine 116.

In operation, initially, the audio generation engine 116 (referred to as engine 116) of the system 102 obtains a list of individual sentences, such as list of individual sentences 124 (referred to as individual sentences) with a speaker identifier assigned to each of the individual sentences 124 which are spoken by different speakers present within a media file. There are many ways to obtain such individual sentences 124 with speaker identifier assigned. One of the possible ways is described below.

The engine 116, initially, obtains an initial media file, such as initial media file 122 including an initial audio track in an initial language and a corresponding initial video track. In one example, the initial media file 122 may be obtained from a user via communicatively coupled computing device or from a data repository, such as data repository 104. Thereafter, the engine 116 performs filtering of the initial audio track to remove background noises from the initial audio track. In an example, the background noises include distant chatter, different kind of sounds generated by different things, etc. The filtering of the initial audio track is performed so as to clearly notice the silences between subsequent sentences spoken in the initial audio track by different speakers. In one example, the initial media file 122 may be a one-to-one discussion of a first speaker and a second speaker with several sentences are spoken by first speaker and several by the second speaker.

The engine 116, thereafter, convert the initial audio track into text which indicates text spoken by the first speaker and the second speaker, as per the above example. Once converted, the text is processed to get segregated into a list of individual sentences, such as individual sentences 124 based on the silences between the subsequent sentences in the initial audio track. For example, the engine 116 process the text to notice silences in the initial audio track and insert flags in between the text portion whenever encounter any silence in between the subsequent sentences to generate the individual sentences 124.

Continuing further, the engine 116 assigns a speaker identifier to each of the individual sentences in the individual sentences 124 based on an initial audio characteristic information of the speakers, e.g., the first speaker and the second speaker. In an example, the first speaker and the second speaker may speak individual sentences with their vocal characteristics, which may be regarded here as audio characteristic information of the respective speaker. Based on such initial audio characteristic information, different individual sentences are marked with different speaker identifier. Examples of speaker identifier includes, but may not be limited to, numerals, alphanumerical numbers, and alphabets. For example, if text of initial audio track shows that there are 5 sentences from which 1^{st}, 3^{rd} and 4^{th} are spoken by first speaker and 2^{nd} and 5^{th} are spoken by second speaker. Thereafter, based on the audio characteristics information of individual sentences, the engine 116 assign speaker identifier to each of the individual sentences 124.

Once the speaker identifiers are assigned to the individual sentences 124, the engine 116 process each of the individual sentences 124 to merge it with preceding sentence or subsequent sentences based on the assigned speaker identifier and grammatical context of the sentences. For example, as explained in above example, 3^{rd} and 4^{th} sentences were spoken by the same speaker, i.e., first speaker but due to silences between the sentences they are segregated into individual sentences. In such a case, the 3^{rd} and the 4^{th} sentences are merged together to form a single sentence. It may be noted that, while generating audio for such merged sentences, the original silence between the two sentences is also added. This process of either merging or partitioning individual sentence is generally known as ‘sentence tokenization’.

On the other hand, there may be a case, that while segregating text into individual sentences 124 due to lack of silence between two subsequent sentences, the sentences may not be segregated into two sentences even they are spoken by different speaker, which may be noticed by grammatical context of the sentences. In such a case, the engine 116 partitions the sentence into two individual sentences based on the assigned speaker identifier and grammatical context. In another example, the incorrect segregation of sentences may be corrected manually by a user operating on the audio generation system 102.

Returning to the present example, once the individual sentences with a speaker identifier assigned are obtained, the engine 116 determine a final audio characteristic information, such as final audio characteristic information 126 for each of the speaker, i.e., the first speaker and the second speaker from a data repository, such as data repository 104 based on a speaker attribute. In an example, the data repository 104 includes a plurality of final audio characteristic information stored with their corresponding speaker attribute in different language categories. Examples of speaker attributes include, but may not be limited to, age, sex, and vocal speed of the speaker. Therefore, based on the speaker attributes, the engine 116 search for a final audio characteristic information from the plurality of final audio characteristic information for the final language. For example, if the first speaker is of 25 years of age and having male sex, then the engine 116 looks for those final audio characteristic information which have 25 years of age with male sex.

Continuing further, the engine 116 generate a final audio portion, such as final audio portion 128, corresponding to each of the individual sentences 124 using an audio generation model, such as audio generation model 118. The engine 116 inputs a final text, such as final text 130 which is to be converted into audio and the final audio characteristic information 126 determined from the data repository 104 into the audio generation model 118 and obtain a final audio portion, such as final audio portion 128 corresponding to each of the individual sentences. As may be described above, the audio generation model 118 is a multi-speaker audio generation model which is trained based on plurality of audio tracks of plurality of speakers to generate the output audio corresponding to input text based on the input audio characteristic information.

In an example, the system 102 includes a neural machine translation model (not shown in FIG. 1) having capabilities of translating text into any language. Such model is capable of providing multiple translations for a single sentence. Therefore, it may be the case that, for each of the individual sentences 124, model generates a plurality of final text.

In such a case, the engine 116 determines an audio portion duration of each of the individual sentence when spoken by a speaker having initial audio characteristic information and an audio portion duration of each of the final texts when spoken by a speaker having final audio characteristic information. Once determined, the engine 116 compare the durations individually for each of the individual sentences 124. Based on the comparison, engine 116 selects the final text 130 from the plurality of final texts for each of the individual sentences 124. For example, whose duration matches or nearly matches, engine 116 selects that final text 130 from the plurality of final text for that individual sentence. In one example, the initial duration of sentence may not be equal to the final duration of sentence. In such a case, the engine 116 manipulates final audio characteristics information, such as duration of phonemes, in such a manner that the final duration matches with the initial duration of audio portions of each of the individual sentences. In another example, the engine 116 may add silences (in case of final duration is less than initial duration) or remove unnecessary silence (in case of final duration is greater than the initial duration) from the final audio portion to make the duration of initial audio portion equivalent to the final audio portion corresponding to each of the individual sentences.

In another example, in case when plurality of final audio characteristics are selected based on the speaker attributes from the data repository 104, the engine 116 may determine duration of speaking the individual sentences for different final audio characteristic information. In such a case, the engine 116 selects a combination of final audio characteristic information 126 and final text 130 based on the comparison of the initial duration with the final duration.

Returning to the present example, once the final audio portion 128 of each of the individual sentences 124 is generated, the engine 116 merge all of the final audio portions to generate a final audio track, such as final audio track 132 dubbed in the final language.

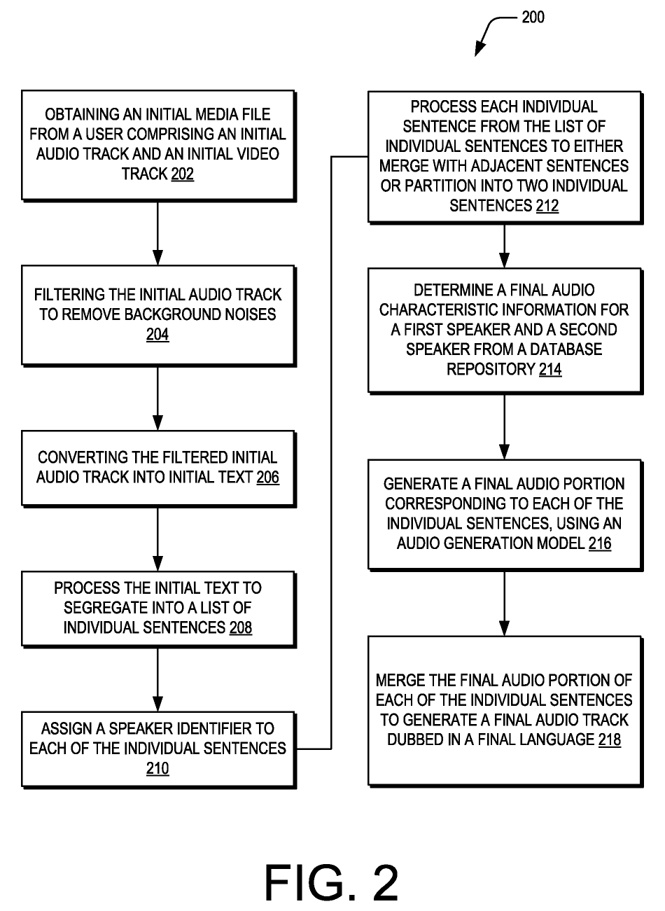

FIG. 2 illustrate example method 200 for converting an initial audio track of an initial language into a final audio track of a final language, in accordance with examples of the present subject matter. The order in which the above-mentioned methods are described is not intended to be construed as a limitation, and some of the described method blocks may be combined in a different order to implement the methods, or alternative methods.

Furthermore, the above-mentioned methods may be implemented in a suitable hardware, computer-readable instructions, or combination thereof. The steps of such methods may be performed by either a system under the instruction of machine executable instructions stored on a non-transitory computer readable medium or by dedicated hardware circuits, microcontrollers, or logic circuits. For example, the methods may be performed by an audio generation system, such as system 102. In an implementation, the methods may be performed under an “as a service” delivery model, where the system 102, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned methods.

In an example, the method 200 may be implemented by the system 102 for converting an initial audio track of an initial language into a final audio track of a final language. At block 202, an initial media file is obtained including an initial audio track and an initial video track. For example, the engine 116, initially, obtains the initial media file 122 including the initial audio track in the initial language and corresponding initial video track. In one example, the initial media file 122 may be obtained from a user via communicatively coupled computing device or from a data repository, such as data repository 104.

At block 204, the initial audio track is filtered to remove background noises. For example, the engine 116 performs filtering of the initial audio track to remove background noises from the initial audio track. In an example, the background noises include distant chatter, different kind of sounds generated by different things, etc. The filtering of the initial audio track is performed so as to clearly notice the silences between subsequent sentences spoken in the initial audio track by different speakers. In one example, the initial media file 122 may be a one-to-one discussion of a first speaker and a second speaker with several sentences are spoken by first speaker and several other by the second speaker.

At block 206, the filtered initial audio track is converted into initial text. For example, the engine 116, thereafter, convert the initial audio track into an initial text which indicates text spoken by the first speaker and the second speaker, as per the above example. The conversion of audio into text may be achieved by using any Speech Recognition system or module which converts the audio track into corresponding text.

At block 208, the initial text is processed to segregate into a list of individual sentences. For example, the text is processed by the engine 116 to get segregated into individual sentences 124 based on the silences between the subsequent sentences in the initial audio track. For example, the engine 116 process the initial text to notice silences in the initial audio track and insert flags in between the initial text portion whenever encounter any silence in between the subsequent sentences to generate the individual sentences 124.

At block 210, a speaker identifier is assigned to each of the individual sentences. For example, the engine 116 assigns a speaker identifier to each of the individual sentences in the individual sentences 124 based on an initial audio characteristic information of the speakers, e.g., the first speaker and the second speaker. In an example, the first speaker and the second speaker may speak individual sentences with their vocal characteristics, which may be regarded here as audio characteristic information of the respective speaker. Based on such initial audio characteristic information, different individual sentences are marked with different speaker identifier. Examples of speaker identifier includes, but may not be limited to, numerals, alphanumerical numbers, and alphabets. For example, if text of initial audio track shows that there are 5 sentences from which 1^{st}, 3^{rd} and 4^{th} are spoken by first speaker and 2^{nd} and 5^{th} are spoken by second speaker. Thereafter, based on the audio characteristics information of individual sentences, the engine 116 assign speaker identifier to each of the individual sentences 124.

At block 212, each of the individual sentences from the list of individual sentences are processed to either merge with adjacent sentences or partition into two individual sentences. For example, the engine 116 process each of the individual sentences 124 to merge it with preceding sentence or subsequent sentences based on the assigned speaker identifier and grammatical context of the sentences. For example, as explained in above example, 3^{rd} and 4^{th} sentences were spoken by the same speaker, i.e., first speaker but due to silences between the sentences they are segregated into individual sentences. In such a case, the 3^{rd} and the 4^{th} sentences are merged together to form a single sentence. It may be noted that, while generating audio for such merged sentences, the original silence between the two sentences is also added.

On the other hand, there may be a case, that while segregating text into individual sentences 124 due to lack of silence between two subsequent sentences, the sentences may not be segregated into two sentences even they are spoken by different speaker, which may be noticed by grammatical context of the sentences. In such a case, the engine 116 partitions the sentence into two individual sentences based on the assigned speaker identifier and grammatical context. This process of either merging or partitioning individual sentence is generally known as ‘sentence tokenization’.

At block 212, a final audio characteristic information for a first speaker and a second speaker is determined from a data repository. For example, the engine 116 determine a final audio characteristic information, such as final audio characteristic information 126 for each of the speaker, i.e., the first speaker and the second speaker from a data repository, such as data repository 104 based on a speaker attribute. In an example, the data repository 104 includes a plurality of final audio characteristic information stored with their corresponding speaker attribute in different language categories. Examples of speaker attributes include, but may not be limited to, age, sex, and vocal speed of the speaker. Therefore, based on the speaker attributes, the engine 116 search for a final audio characteristic information from the plurality of final audio characteristic information for the final language. For example, if the first speaker is of 25 years of age and having male sex, then the engine 116 looks for those final audio characteristic information which have 25 years of age with male sex.

At block 216, a final audio portion is generated corresponding to each of the individual sentences using an audio generation model based on a final text. For example, the engine 116 generate a final audio portion, such as final audio portion 128, corresponding to each of the individual sentences 124 using an audio generation model, such as audio generation model 118. The engine 116 inputs the final text 130 which is to be converted into audio and the final audio characteristic information 126 determined from the data repository 104 into the audio generation model 118 and obtain a final audio portion, such as final audio portion 128 corresponding to each of the individual sentences. As may be described above, the audio generation model 118 is a multi-speaker audio generation model which is trained based on plurality of audio tracks of plurality of speakers to generate the output audio corresponding to input text based on the input audio characteristic information.

In an example, the system 102 includes a neural machine translation model (not shown in FIG. 1) having capabilities of translating text into any language. Such model is capable of providing multiple translations for a single sentence. Therefore, it may be the case that, for each of the individual sentences 124, model generates a plurality of final text.

In such a case, the engine 116 determines an audio portion duration of each of the individual sentence when spoken by a speaker having initial audio characteristic information and an audio portion duration of each of the final texts when spoken by a speaker having final audio characteristic information. Once determined, the engine 116 compare the durations individually for each of the individual sentences 124. Based on the comparison, engine 116 selects the final text 130 from the plurality of final texts for each of the individual sentences 124. For example, whose duration matches or nearly matches, engine 116 selects that final text 130 from the plurality of final text for that individual sentence.

In one example, the initial duration of sentence may not be equal to the final duration of sentence. In such a case, the engine 116 manipulates final audio characteristics information, such as duration of phonemes, in such a manner that the final duration matches with the initial duration of audio portions of each of the individual sentences. In another example, the engine 116 may add silences (in case of final duration is less than initial duration) or remove unnecessary silence (in case of final duration is greater than the initial duration) from the final audio portion to make the duration of initial audio portion equivalent to the final audio portion corresponding to each of the individual sentences.

In another example, in case when plurality of final audio characteristics are selected based on the speaker attributes from the data repository 104, the engine 116 may determine duration of speaking the individual sentences for different final audio characteristic information. In such a case, the engine 116 selects a combination of final audio characteristic information 126 and final text 130 based on the comparison of the initial duration with the final duration.

At block 218, the final audio portion of each of the individual sentences are merged to generate a final audio track dubbed in a final language. For example, the engine 116 merge all of the final audio portions to generate a final audio track, such as final audio track 132 dubbed in the final language.

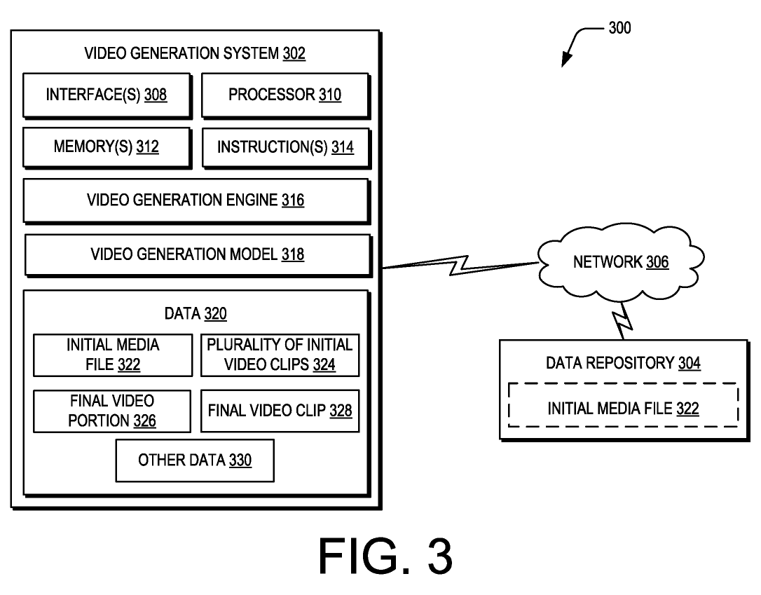

FIG. 3 illustrates a communication environment 300, depicting a detailed block diagram of a video generation system 302 (referred to as system 302), for manipulating or altering movement of lips of a speaker in an initial video track based on a final audio track and a final text corresponding to each individual sentences. In an example, the final audio track is the audio track which is determined by the audio generation system, such as system 102 to replace the initial audio track from the initial media file 122.

In general, the system 302 generates a final video portion having a final visual characteristic information based on the final audio characteristic information and the final text to replace an initial video portion from the initial video track. The system 302, in an example, may relate to any system capable of receiving user’s inputs, processing it, and correspondingly providing output based on the received user’s inputs.

The system 302 may be coupled to a data repository 304 over a communication network 306 (referred to as network 306). The data repository 304 may be implemented using a single storage resource (e.g., a disk drive, tape drive, etc.), or may be implemented as a combination of communicatively linked storage resources (e.g., in the case of Infrastructure-as-a-service), without deviating from the scope of the present subject matter.

The network 306 may be either a single communication network or a combination of multiple communication networks and may use a variety of different communication protocols. The network 306 may be a wireless network, a wired network, or a combination thereof. Examples of such individual communication networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NON), Public Switched Telephone Network (PSTN). Depending on the technology, the network 306 includes various network entities, such as gateways, routers; however, such details have been omitted for the sake of brevity of the present description.

The system may include interface(s) 308, processor 310, and a memory 312. The interface(s) 308 may allow the connection or coupling of the system 302 with one or more other devices, through a wired (e.g., Local Area Network, i.e., LAN) connection or through a wireless connection (e.g., Bluetooth®, WiFi). The interface(s) 308 may also enable intercommunication between different logical as well as hardware components of the system 302. The processor 310 may be implemented as microprocessors, microcomputers, microcontrollers, digital signal processors, central processing units, state machines, logic circuitries, and/or any devices that manipulate signals based on operational instructions. Among other capabilities, the processor 310 is configured to fetch and execute computer-readable instructions stored in the memory 312.

The memory 312 may be a computer-readable medium, examples of which include volatile memory (e.g., RAM), and/or non-volatile memory (e.g., Erasable Programmable read-only memory, i.e., EPROM, flash memory, etc.). The memory 312 may be an external memory, or internal memory, such as a flash drive, a compact disk drive, an external hard disk drive, or the like. The memory 312 may further include data which either may be utilized or generated during the operation of the system 302.

The system 302 may further include instructions 314 and a video generation engine 316. In an example, the instructions 314 are fetched from the memory 312 and executed by the processor 310 included within the system 302. The video generation engine 316 may be implemented as a combination of hardware and programming, for example, programmable instructions to implement a variety of functionalities. In examples described herein, such combinations of hardware and programming may be implemented in several different ways. For example, the programming for the video generation engine 316 may be executable instructions, such as instructions 314.

Such instructions may be stored on a non-transitory machine-readable storage medium which may be coupled either directly with the system 302 or indirectly (for example, through networked means). In an example, the video generation engine 316 may include a processing resource, for example, either a single processor or a combination of multiple processors, to execute such instructions. In the present examples, the non-transitory machine-readable storage medium may store instructions, such as instructions 314, that when executed by the processing resource, implement video generation engine 316. In other examples, the video generation engine 316 may be implemented as electronic circuitry.

The system 302 may further include a video generation model 318. In an example, the video generation model 318 may be a multi-speaker video generation model which is trained based on a number of video tracks corresponding to multiple speakers to generate an output video displaying portion of the speaker’s face in which the lips of the speaker visually moved in such a manner that speaker is speaking an input audio corresponding to an input text. In an example, the video generation model 318 may also be trained based on the initial video track and initial list of individual sentences.

In an example, the system 302 may further include a training engine (not shown in FIG. 1) for training the video generation model 318. In one example, the training engine obtains the training information either from the user operating on the computing device or from the sample data repository, such as data repository 304. Thereafter, a training audio characteristic information is extracted by the training engine using the training audio data and the training text data spoken in each of the plurality of training video frames. In an example, the training audio characteristic information is extracted from the training audio data using phoneme level segmentation of training text data. The training audio characteristic information further includes plurality of training attribute values for the plurality of training audio characteristics. Examples of training audio characteristics include, but may not be limited to, type of phonemes present in the training audio data, number of phonemes, duration of each phoneme, pitch of each phoneme, and energy of each phoneme.

Thereafter, a training visual characteristic information is extracted by the training engine using the plurality of training video frames. In an example, the training visual characteristic information is extracted from the training video frames using image feature extraction techniques. It may be noted that other techniques may also be used to extract the training visual characteristic information from the training video frames. The training visual characteristic information further includes training attribute values for the plurality of training visual characteristics. Example of training visual characteristics include, but may not be limited to, color, tone, pixel value of each of the plurality of pixel, dimension, and orientation of the speaker’s face based on the training video frames.

Continuing with the present example, once the training audio characteristic information and the training visual characteristic information are extracted, the training engine trains the video generation model based on the training audio characteristic information and the training visual characteristic information. In an example, while training the video generation model, the training engine classify each of the plurality of final visual characteristics comprised in the final visual characteristic information as one of a plurality of pre-defined visual characteristic categories based on the processing of the attribute values of the training audio characteristic information and the training visual characteristic information.

Once classified, the training engine assigns a weight for each of the plurality of final visual characteristics based on the training attribute values of the training audio characteristics and the training visual characteristic information. In an example, the trained video generation model includes an association between the training audio characteristic information and training visual characteristic information. Such association may be used at the time of inference to identify final visual characteristic information of a final video portion.

In another example, the video generation model may be trained by the training engine in such a manner that the video generation model is made ‘overfit’ to predict a specific output video portion. For example, the video generation model is trained by the training engine based on the initial video track and the initial audio track. Once trained to be overfit, the video generation model generates an output video portion which may be similar to the portion of the initial video track as it is without any change and having corresponding visual characteristic information.

Returning to the present example, once the video generation model is trained, it may be utilized for altering or modifying any initial video track to a final video track. The manner in which the initial video track is modified or altered to the final video track is further described below.

Returning the explanation of features of the system 302, the system 302 further includes a data 320 including an initial media file 322, a plurality of initial video clips 324, final video portion 326, a final video clip 328, and other data 330. Further, the other data 330, amongst other things, may serve as a repository for storing data that is processed, or received, or generated as a result of the execution of instructions by the processing resource of the video generation engine 316.

In operation, initially, the video generation engine 316 (referred to as engine 316) of the system 302 obtains an initial media file, such as initial media file 322 including an initial audio track in an initial language, an initial video track, and an initial audio portion, a final audio portion, and a final text corresponding to each of the individual sentences spoken in the initial media file 322. In one example, the initial media file 322 may be obtained from a user via communicatively coupled computing device or from a data repository, such as data repository 304. In an example, the initial audio portion, the final audio portion, and the final text corresponding to each of the individual sentences spoken in the initial media file 322 is obtained from the system 102 which may be generated while converting the initial audio track into final audio track. For example, while converting the initial audio track into the final audio track, initial audio portions corresponding to each of the sentences have been determined to convert them into final audio portions based on the final text. Therefore, the initial audio portion, final audio portion, and final text corresponding to each of the individual sentences generated while converting the initial audio track into the final audio track are used here.

Thereafter, the engine 316 split the initial video track into a plurality of initial video clips 324 (referred to as initial video clips 324) based on the duration of each of the initial audio portions. For example, while processing the initial audio track of the initial media file, the engine 116 has determined which sentence has been spoken by which speaker and generated a list of individual sentences, such as individual sentences 124 with speaker identifier assigned. Based on the generated list of individual sentences, duration for vocalizing individual sentence by the speaker is determined. Based on the determined duration, the initial video track is split by the engine 316 into initial video clips 324. In an example, the initial video track is split into initial video clips 324 based on the duration of final audio portion which is obtained after manipulating the final audio characteristic information or by adding or removing silences based on the difference between the initial duration and the final duration.

Returning to the present example, once the initial video clips 324 are obtained, the engine 316 determines presence of a speaker’s face speaking the corresponding individual sentence in each of the initial video clips using face detection techniques. If engine 316 on determination confirms presence of speaker’s face, then the engine 316 proceed to further process the corresponding initial video clip. On the other hand, if engine 316 on determination confirms non-presence of speaker’s face, then the engine 316 left that initial video clip as it is and jumps onto to process the subsequent video clips.

Once presence of speaker’s face is confirmed, the engine 316 process the initial video clip with corresponding final audio portion, final text, and an initial visual characteristics information based on a video generation model, such as video generation model 318, to generate a final video portion, such as final video portion 326. In an example, the final video portion 326 corresponding to each of the initial video clips includes a portion of speaker’s face visually interpreting movement of lips corresponding to the final audio portion 128 and final text 130.

In one example, while processing the initial video clips 324, engine 316 extracts a final audio characteristic information from the final audio portion based on the phoneme level segmentation of the final text. In an example, the final audio characteristic information comprises attribute values for a plurality of audio characteristics. Examples of audio characteristics include, but may not be limited to, number of phonemes, a type of each phoneme present in the initial audio track, duration of each phoneme, pitch of each phoneme, and energy of each phoneme.

Thereafter, the engine 316 extracts initial visual characteristic information from the initial video clip. In an example, the initial visual characteristic information includes attributes values for a plurality of initial visual characteristics. Examples of initial visual characteristics include, but may not be limited to, color, tone, pixel value of each of the plurality of pixel, dimension, and orientation of the speaker’s face based on the initial video frames.

Once extracted, the final audio characteristic information and the initial visual characteristic information is processed based on the video generation model 318 to assign a weight for each of the plurality of final visual characteristics comprised in a final visual characteristic information to generate a weighted final visual characteristic information. Thereafter, the engine 316 generates the final video portion 326 corresponding to the initial video clip to be merged with an intermediate video clip to obtain a final video clip, such as final video clip 328, corresponding to each of the initial video clips 324.

Once the final video clip 328 corresponding to each of the initial video clips are obtained, the engine 316 combines or merges the final video clips into one final video track to be combined with final audio track to generate a final media file.

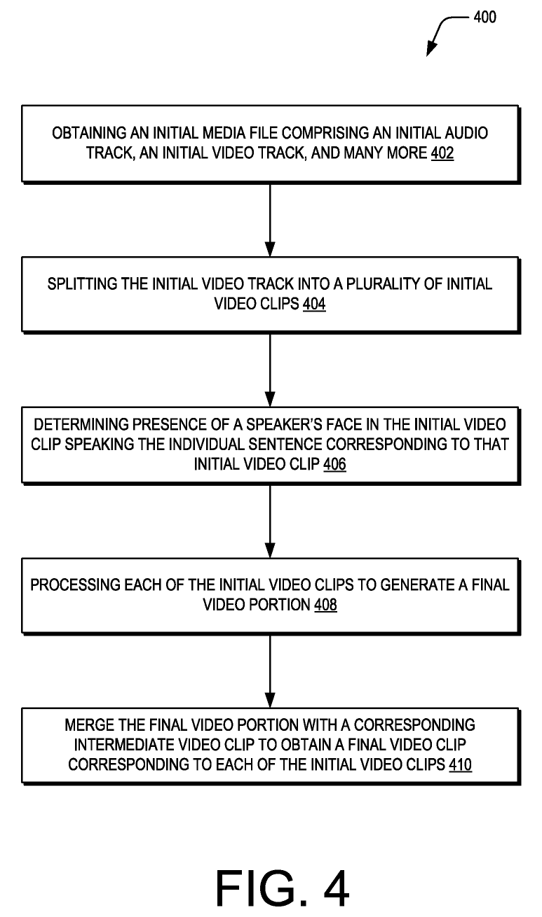

FIGS. 4 illustrate example method 400 for manipulating or altering movement of lips of a speaker in an initial video track based on a final audio track and a final text corresponding to each individual sentences, in accordance with examples of the present subject matter. The order in which the above-mentioned methods are described is not intended to be construed as a limitation, and some of the described method blocks may be combined in a different order to implement the methods, or alternative methods.

Furthermore, the above-mentioned methods may be implemented in a suitable hardware, computer-readable instructions, or combination thereof. The steps of such methods may be performed by either a system under the instruction of machine executable instructions stored on a non-transitory computer readable medium or by dedicated hardware circuits, microcontrollers, or logic circuits. For example, the methods may be performed by a video generation system, such as system 302. In an implementation, the methods may be performed under an “as a service” delivery model, where the system 302, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned methods.

In an example, the method 400 may be implemented by the system 302 for manipulating or altering movement of lips of a speaker in an initial video track based on a final audio track and a final text corresponding to each individual sentences. At block 402, an initial media file including an initial audio track, an initial video track, and many more is obtained. For example, the engine 316 of the system 302 obtains the initial media file 322 including an initial audio track in an initial language, an initial video track, and an initial audio portion, a final audio portion, and a final text corresponding to each of the individual sentences spoken in the initial media file 322. In one example, the initial media file 322 may be obtained from a user via communicatively coupled computing device or from a data repository, such as data repository 304. In an example, the initial audio portion, the final audio portion, and the final text corresponding to each of the individual sentences spoken in the initial media file 322 is obtained from the system 302 which may be generated while converting the initial audio track into final audio track.

At block 404, the initial video track is divided into a plurality of initial video clips. For example, the engine 316 split the initial video track into a plurality of initial video clips, such as initial video clips 324 based on the duration of each of the initial audio portions. For example, while processing the initial audio track of the initial media file 322, the engine 116 has determined which sentence has been spoken by which speaker and generated a list of individual sentences, such as individual sentences 124 with speaker identifier assigned. Based on the generated list of individual sentences, duration for vocalizing individual sentence by the speaker is determined. Based on the determined duration, the initial video track is split by the engine 316 into initial video clips 324. In an example, the initial video track is split into initial video clips 324 based on the duration of final audio portion which is obtained after manipulating the final audio characteristic information or by adding or removing silences based on the difference between the initial duration and the final duration.

At block 406, a presence of a speaker’s face in each of the initial video clips is determined as speaking the individual sentence corresponding to that initial video clip. For example, the engine 316 determines presence of a speaker’s face speaking the corresponding individual sentence in each of the initial video clips using face detection techniques. If engine 316 on determination confirms presence of speaker’s face, then the engine 316 proceed to further process the corresponding initial video clip. On the other hand, if engine 316 on determination confirms non-presence of speaker’s face, then the engine 316 left that initial video clip as it is and jumps onto to process the subsequent video clips.

At block 408, each of the initial video clips having speaker’s face are processed to generate a final video portion based on a video generation model. For example, the engine 316 process the initial video clip with corresponding final audio portion, final text, and an initial visual characteristics information based on a video generation model, such as video generation model 318, to generate a final video portion, such as final video portion 326. In an example, the final video portion 326 corresponding to each of the initial video clips includes a portion of speaker’s face visually interpreting movement of lips corresponding to the final audio portion 128 and final text 130.

At block 410, the final video portion is merged with a corresponding intermediate video clip to obtain a final video clip corresponding to each of the initial video clips. For example, the engine 316 combines or merges the final video clips into one final video track to be combined with final audio track to generate a final media file.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

1. A system comprising:
a processor;
a video generation engine coupled to the processor, wherein the video generation engine is to:
obtain an initial media file comprising an initial audio track, an initial video track, and an initial audio portion, a final audio portion, and a final text corresponding to each of the individual sentences spoken in the initial media file;
split the initial video track into a plurality of initial video clips based on the duration of each of the initial audio portions, wherein the each of the initial video clips represent video data with individual sentence corresponding to that video clip being spoken in the initial video track;
process each of the initial video clips with corresponding final audio portion, final text, and an initial visual characteristic information based on a video generation model to generate a final video portion corresponding to each of the initial video clips, wherein the processing of the each of the initial video clips is to:
provide the final video portion corresponding to each of the initial video clips comprising a portion of a speaker’s face visually interpreting movement of lips corresponding to the final audio portion and final text; and
merge the final video portion with a corresponding intermediate video clip to obtain a final video clip corresponding to each of the initial video clips.

2. The system as claimed in claim 1, wherein the video generation model is a multi-speaker video generation model which is pre-trained based on a number of video tracks corresponding to each of the speaker to generate an output video displaying portion of the speaker’s face visually interpreting movement of lips corresponding to an input text and an input audio.

3. The system as claimed in claim 1, wherein to process the each of the initial video clips with corresponding final audio portion and final text based on the video generation model, the video generation engine is to:
extract a final audio characteristic information from the final audio portion based on the phoneme level segmentation of the final text, wherein the final audio characteristic information comprises attribute values for a plurality of audio characteristics;
extract an initial visual characteristic information from the initial video clip, wherein the initial visual characteristic information comprises attributes values for a plurality of initial visual characteristics;
process the final audio characteristic information and the initial visual characteristic information based on the video generation model to assign a weight for each of a plurality of final visual characteristics comprised in a final visual characteristic information to generate a weighted final visual characteristics information; and
based on the weighted final visual characteristic information, generate the final video portion corresponding to the initial video clip.

4. The system as claimed in claim 1, wherein before processing each of the initial video clips, the video generation model is to:
determine presence of a speaker’s face speaking the individual sentence in each of the initial video clips using face detection techniques; and
based on the determination, process each of the initial video clips with corresponding final audio portion and final text based on the video generation model to generate the final video portion corresponding to each of the initial video clips.

5. The system as claimed in claim 1, wherein the intermediate video clip comprises video data corresponding to initial video clip with a portion displaying lips of a speaker blacked out.

6. The system as claimed in claim 3, wherein the plurality of audio characteristics comprises number of phonemes, a type of each phoneme present in the initial audio track, duration of each phoneme, pitch of each phoneme, and energy of each phoneme.

7. The system as claimed in claim 3, wherein the initial visual characteristics comprises color, tone, pixel value of each of the plurality of pixel, dimension, and orientation of the speaker’s face based on the initial video frames and the final visual characteristics comprising color, tone, pixel value of each of the plurality of pixel, dimension, and orientation of the lips of the speaker.

8. A method comprising:
obtaining an initial media file comprising an initial audio track, an initial video track, and an initial audio portion, a final audio portion, and a final text corresponding to each of the individual sentences spoken in the initial media file;
splitting the initial video track into a plurality of initial video clips based on the duration of each of the initial audio portions, wherein the each of the initial video clips represent video data with individual sentence corresponding to that video clip being spoken in the initial video track;
processing each of the initial video clips with corresponding final audio portion, final text, and an initial visual characteristic information based on a video generation model to generate a final video portion corresponding to each of the initial video clips, wherein the processing of the each of the initial video clips comprises:
providing the final video portion corresponding to each of the initial video clips comprising a portion of a speaker’s face visually interpreting movement of lips corresponding to the final audio portion and final text; and
merging the final video portion with a corresponding intermediate video clip to obtain a final video clip corresponding to each of the initial video clips.

9. The method as claimed in claim 8, wherein the video generation model is a multi-speaker video generation model which is pre-trained based on a number of video tracks corresponding to each of the speaker to generate an output video displaying portion of the speaker’s face visually interpreting movement of lips corresponding to an input text and an input audio.

10. The method as claimed in claim 8, wherein while processing the each of the initial video clips with corresponding final audio portion and final text based on the video generation model, the method comprises:
extracting a final audio characteristic information from the final audio portion based on the phoneme level segmentation of the final text, wherein the final audio characteristic information comprises attribute values for a plurality of audio characteristics;
extracting an initial visual characteristic information from the initial video clip, wherein the initial visual characteristic information comprises attributes values for a plurality of initial visual characteristics;
processing the final audio characteristic information and the initial visual characteristic information based on the video generation model to assign a weight for each of a plurality of final visual characteristics comprised in a final visual characteristic information to generate a weighted final visual characteristics information; and
based on the weighted final visual characteristic information, generating the final video portion corresponding to the initial video clip.

11. The method as claimed in claim 8, wherein before processing each of the initial video clips, the method further comprises:
determining presence of a speaker’s face speaking the individual sentence in each of the initial video clips using face detection techniques; and
based on the determination, processing each of the initial video clips with corresponding final audio portion and final text based on the video generation model to generate the final video portion corresponding to each of the initial video clips.

12. The method as claimed in claim 8, wherein the intermediate video clip comprises video data corresponding to initial video clip with a portion displaying lips of a speaker blacked out.

13. The method as claimed in claim 10, wherein the plurality of audio characteristics comprises number of phonemes, a type of each phoneme present in the initial audio track, duration of each phoneme, pitch of each phoneme, and energy of each phoneme.

14. The method as claimed in claim 10, wherein the initial visual characteristics comprises color, tone, pixel value of each of the plurality of pixel, dimension, and orientation of the speaker’s face based on the initial video frames and the final visual characteristics comprising color, tone, pixel value of each of the plurality of pixel, dimension, and orientation of the lips of the speaker.

15. A non-transitory computer-readable medium comprising instructions, the instructions being executable by a processing resource to:
obtain a list of individual sentences with a speaker identifier assigned to each of the individual sentences, wherein the list of individual sentences corresponds to sentences spoken by a first speaker and a second speaker present within an initial video track;
determine a final audio characteristic information for the first speaker and the second speaker from a data repository for a final language based on a speaker attribute of the first speaker and the second speaker;
generate a final audio portion corresponding to each of the individual sentences, using an audio generation model, based on the final audio characteristics determined for each speaker and a final text determined corresponding to each of the individual sentences; and
merge the final audio portion of each of the individual sentences to generate a final audio track dubbed in the final language;
split the initial video track into a plurality of initial video clips based on the duration of each of the initial audio portions, wherein the each of the initial video clips represent video data with individual sentence corresponding to that video clip being spoken in the initial video track;
process each of the initial video clips with corresponding final audio portion, final text, and an initial visual characteristic information based on a video generation model to generate a final video portion corresponding to each of the initial video clips, wherein the processing of the each of the initial video clips is to:
provide the final video portion corresponding to each of the initial video clips comprising a portion of a speaker’s face visually interpreting movement of lips corresponding to the final audio portion and final text; and
merge the final video portion with a corresponding intermediate video clip to obtain a final video clip corresponding to each of the initial video clips and merge the plurality of final video clips to obtain a final video track; and
associate the final audio track with the final video track to obtain a final media file.

16. The non-transitory computer-readable medium as claimed in claim 15, the instructions being executable by a processing resource to:
obtain an initial media file from a user, wherein the initial media file comprises an initial audio track in an initial language and the initial video track;
filter the initial audio track to remove background noises;
convert the filtered audio track into text, wherein the text comprises text spoken by the first speaker and the second speaker;
process the text to segregate into the list of individual sentences based on silences between the subsequent sentences in the initial audio track; and
assign the speaker identifier for each of the individual sentences based on an initial audio characteristic information of each of the initial speakers.

17. The non-transitory computer-readable medium as claimed in claim 15, wherein the audio generation model is a multi-speaker audio generation model which is pre-trained based on a plurality of audio tracks of a plurality of speakers to generate an output audio corresponding to an input text based on input audio characteristic information.

18. The non-transitory computer-readable medium as claimed in claim 15, wherein the video generation model is a multi-speaker video generation model which is pre-trained based on a number of video tracks corresponding to each of the speaker to generate an output video displaying portion of the speaker’s face visually interpreting movement of lips corresponding to an input text and an input audio.
